(19) United States
(12) Patent Application Publication
(10) Pub. No.: US 2010/0173574 A1
(43) Pub. Date: Jul. 8, 2010

(54) DISEMBOWELING TOOL AND METHODS FOR DISEMBOWELING AN ANIMAL

(76) Inventors: Kim R. Gass, Portage, WI (US); Clyde H. Masten, III, Portage, WI (US)

Correspondence Address: LATHROP & CLARK LLP, 740 REGENT STREET SUITE 400, P.O. BOX 1507, MADISON, WI, 537011507, US

(21) Appl. No.: 12/570,674

(22) Filed: Sep. 30, 2009

Related U.S. Application Data
(60) Provisional application No. 61/143,269, filed on Jan. 8, 2009.

(51) Int. Cl. A22C 21/06; A22B 5/18

(52) U.S. Cl. 452/117

(57) ABSTRACT

A tool usable for disemboweling fowl or other game animals includes a handle, a shank extending from the handle and a plurality of barbs extending radially from the shank. The plurality of barbs can be located on fins extending radially from the shank or arranged in columns extending the length of the shank. Each fin or column includes multiple barbs of a first size and/or shape and multiple barbs of a second size and/or shape. In general, the tool is shaped to be easily insertable and advanceable into the cloaca of a fowl or other game animal and to readily engage a portion of the gastrointestinal tract of the animal, such that, when retracted, the tool will remove at least a portion of the gastrointestinal tract of the animal and may remove other desired internal organs of the animal.

This application claims priority to U.S. Provisional Application 61/143,269, filed Jan. 8, 2009, which is incorporated herein by reference in its entirety.

### BACKGROUND

1. Field

This invention is generally related to field dressing devices. This invention is more particularly related to tools and methods for disemboweling an animal, such as, for example, fowl, poultry or other birds.

2. Background

In the sport of hunting, such as, for example, in turkey or goose hunting, after killing a bird, the hunter frequently dresses the bird carcass in the field, rather than waiting to dress the bird at a later time and/or at another place. Likewise, poultry growers may also dress bird carcasses manually (e.g., with limited use of mechanical aids). Dressing a bird carcass includes separating the meat from the non-edible internal organs, especially the gastrointestinal tract, or vice versa. It is often desirable and/or necessary to dress a bird carcass as soon as possible after the bird has been killed. One reason for dressing a bird carcass quickly after the bird has been killed is to remove any decomposing material (e.g., partially or completely digested food) located in the gastrointestinal tract of the bird.

### SUMMARY OF DISCLOSED EMBODIMENTS

As outlined above, it is often desirable and/or necessary to dress a bird carcass shortly after the bird has been killed to remove decomposing material located in the gastrointestinal tract of the bird. Often this requires manually (e.g., with limited use of mechanical aids) dressing the bird carcass. Manually dressing a bird carcass can be a messy, hands-on process requiring a substantial amount of skill to be done correctly. If a bird carcass is not dressed correctly, the gastrointestinal tract may be damaged and solid waste matter may be exposed to the body cavity of the bird carcass. When this happens, the meat that comes into contact with the solid waste material becomes contaminated and is not considered fit for consumption. In addition, manually dressing a bird carcass may involve the dresser coming into direct and/or continued contact with the gastrointestinal tract of, and/or solid waste matter from, the bird carcass. Likewise, manually dressing a bird can result in spilling a substantial amount of blood from the bird carcass, which can be messy and/or unsanitary.

This invention provides tools usable to field dress an animal carcass.

This invention separately provides tools usable to remove at least a portion of a gastrointestinal tract of an animal carcass without needing to cut into that animal.

This invention separately provides methods for field dressing an animal carcass.

This invention separately provides methods for removing at least a portion of a gastrointestinal tract of an animal carcass without needing to cut into that animal.

In various exemplary embodiments, the tools according to this invention are lightweight and/or easy to carry, and are usable by a hunter while hunting. In various exemplary embodiments, a tool according to this invention has a shank including a tip sized for insertion into the gastrointestinal tract of an animal (e.g., through a cloaca of a bird) and at least one fin that extends radially from the shank. In various exemplary embodiments, one or more fins include and/or define multiple barbs (e.g., hooks) along an outer periphery of such a fin. When the tip and fins are inserted into, for example, the cloaca of a bird and further into the gastrointestinal tract of that bird, the gastrointestinal tract of that bird is radially stretched. In various exemplary embodiments, the tool is then manipulated (e.g., the tool is rotated about an axis of the shank) to help the barbs grasp and/or engage the gastrointestinal tract of the bird. In various exemplary embodiments, the tool is then retracted from the cloaca, pulling at least a portion of the gastrointestinal tract out of the bird as the tool is retracted.

A tool according to this invention includes a handle, a shank extending from the handle, a tip at an end of the shank and at least one fin extending radially form the shank. One or more fins of the tool include and/or define a plurality of barbs extending away from the shank of the tool.

In various exemplary embodiments of a method according to this invention the tip of the tool is inserted into the gastrointestinal tract of an animal (e.g., into a cloaca of a bird). The handle is pushed or advanced into the body cavity of the animal carcass at least a distance, equal to at least one fin and at least some of the barbs, into the body cavity of the animal carcass. Once at least one fin is sufficiently inserted into the body cavity and/or a sufficient number of the barbs are inserted into the body cavity, the tool is manipulated (e.g., being rotated about an axis of the shank) to help the barbs grasp and/or engage a wall of a gastrointestinal tract of the animal carcass. The tool is then retracted (e.g., by pulling the handle) away from the animal carcass to remove the fins and the barbs of the tool from the body cavity of the animal carcass. This removes at least a portion of the gastrointestinal tract and/or a portion of one or more other internal organs of the animal carcass from the body cavity of the animal carcass. According to this invention, the extracted portion of the gastrointestinal tract and/or portion of one or more other internal organs can then be tied off and/or severed from the animal carcass and discarded.

These and other features and advantages of various exemplary embodiments of systems and methods according to this invention are described in, or are apparent from, the following detailed descriptions of various exemplary embodiments of various devices, structures and/or methods according to this invention.

### BRIEF DESCRIPTION OF DRAWINGS

Various exemplary embodiments of the systems and methods according to this invention will be described in detail, with reference to the following figures, wherein:

FIG. 1 is an isometric view of an exemplary embodiment of a disemboweling tool according to this invention;

FIG. 2 is a front plan view of the disemboweling tool shown in FIG. 1;

FIG. 3 is a side plan view of the disemboweling tool shown in FIG. 1;

FIG. 4 is a top plan view of the disemboweling tool shown in FIG. 1;

FIG. 5 is a bottom plan view of the disemboweling tool shown in FIG. 1; and

FIG. 6 is a flowchart outlining an exemplary embodiment of a method for disemboweling an animal carcass using the disemboweling tool shown in FIG. 1.

### DETAILED DESCRIPTION OF EXEMPLARY EMBODIMENTS

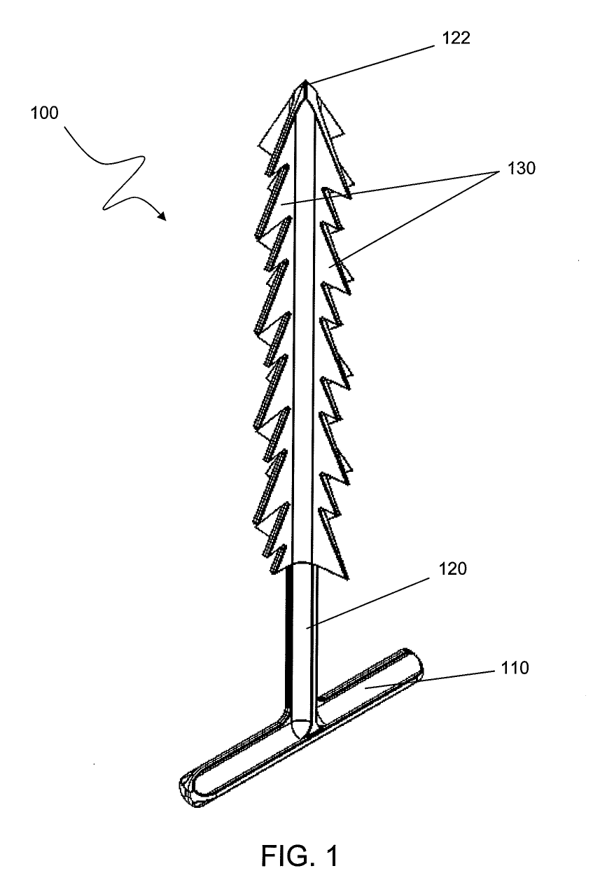

FIG. 1 is a perspective view of an exemplary embodiment of a disemboweling tool 100 according to this invention. As shown in FIG. 1, in various exemplary embodiments, the disemboweling tool 100 includes a handle 110. A shank 120 extends from the handle 110 to a point 122. Multiple fins 130 radially extend from the shank 120. It should be appreciated that, although the exemplary embodiment of the disemboweling tool 100 shown in FIG. 1 includes four fins 130, other exemplary embodiments of the disemboweling tool 100 can include any desired number of the fins 130.

In various exemplary embodiments, the fins 130 are spaced equally around the circumference of the shank 120. In various other exemplary embodiments, the fins 130 are not distributed equally around the circumference of the shaft 120. In still other exemplary embodiments, the fins 130 spiral or wrap around at least a portion of the circumference of the shaft 120. In various ones of such exemplary embodiments, one fin 130 can extend over various angular extents, such as 1°, 5°, 10°, 22°, 45°, 90°, 180°, 360° or any other desired angular extent.

In the exemplary embodiment shown in FIGS. 1-3, each fin 130 extends perpendicularly from the surface of the shank 120. In various exemplary embodiments, one or more of the fins 130, one or more portions of one or more fins 130, or one or more of the barb 132 and/or 134 may be at an angle other than 90° to the surface of the shank 120. For example, in some exemplary embodiments, various ones of the barbs 132 and/or 134 on the various fins 130 extend from the surface of the shank 120 at an angle of about 1° to about 45° in the clockwise direction of the shank 120. Thus, when the shank 120 is rotated in the clockwise direction by the user before and/or as the tool 100 is removed from the animal carcass, the barbs 132 and 134 are able to more deeply engage the gastrointestinal tract of the animal carcass.

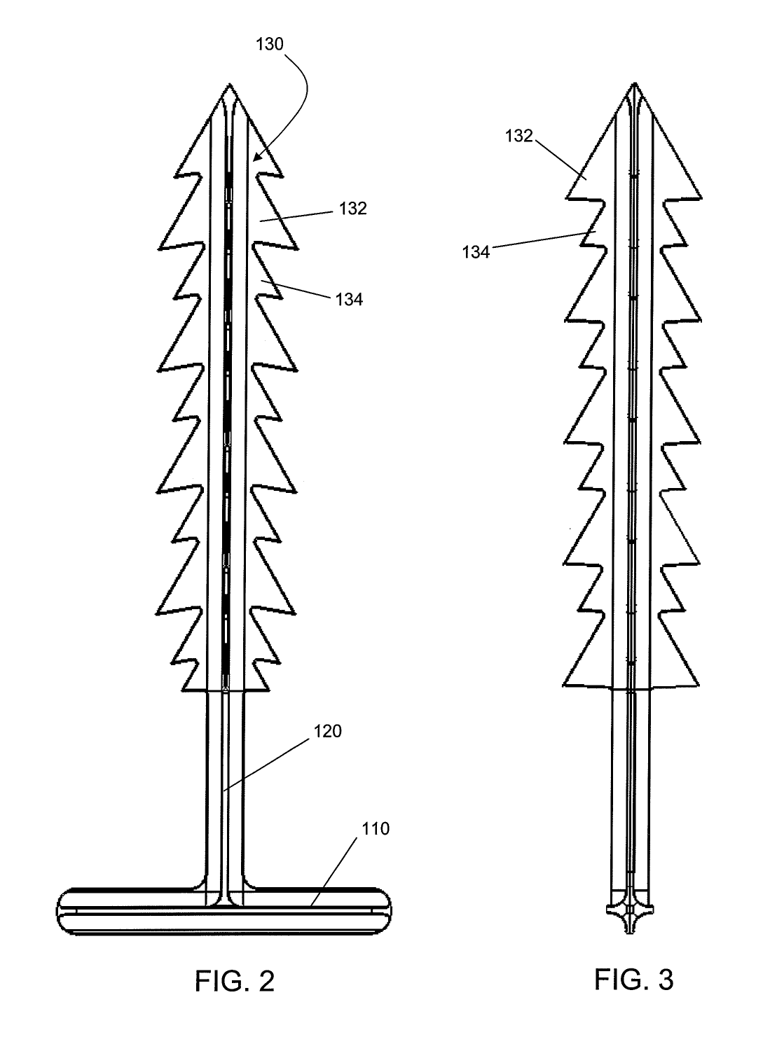

FIGS. 2 and 3 are front and side plan views, respectively, of the exemplary embodiment of the disemboweling tool 100 shown in FIG. 1. As shown in FIGS. 2 and 3, in various exemplary embodiments, the disemboweling tool 100 is symmetric about an axis of the shank 110 (e.g., bilaterally symmetric, radially symmetric, etc). Furthermore, in various exemplary embodiments, the disemboweling tool 100 includes an even number of fins 120 approximately equally distributed around the circumference of the shank 120 with opposing pairs of the fins 130 being generally similarly, or even identically, shaped, and adjacent fins being either similarly shaped or having different shapes.

In various exemplary embodiments, at least one, and up to all, of the fins 130 includes one or more barbs of a first design (e.g., a first size and/or shape) and one or more barbs of a second design (e.g., a second size and/or shape), which can be arranged in any order or pattern along these fins 130. In various other exemplary embodiments, for at least one, and up to all, of the fins 130, the barbs 132 and 134 have the same design ((e.g., size and/or shape). In still other exemplary embodiments, at least one of the fins 130 includes one or more barbs of a first design and one or more barbs of a second design, while, for at least one different one of the fins 130, the barbs 132 and 134 have the same design. In some such exemplary embodiments, a first set of two opposing fins 130 include barbs 132 and 134 having a single design, while a second set of two opposing fins 130 include barbs 132 having a first design and barbs 134 having a second design. In yet other exemplary embodiments, one, more or all of the fins 130 can have barbs 132 et al. having three or more different designs.

In the exemplary embodiment shown in FIG. 2, each fin 130 includes a plurality of large barbs 132 and a plurality of small barbs 134 arranged in an alternating order. In the exemplary embodiment shown in FIG. 2, the large barbs 132 and the small barbs 134 are each generally triangular in shape, with one edge of each triangle connected to the shank 120 and an opposing vertex of that triangle pointing away from the tip 122. It should be appreciated that, while the barbs 132 and 134 shown in FIG. 2 are generally triangularly shaped, the barbs 132 and 134 may be any desired shape. For example, in various exemplary embodiments, the barbs 132 and 134 of one or more fin 130 may be hook-shaped and may be provided at any desired angle relative to that fin 130 and/or relative to the shank 110. Likewise, in various exemplary embodiments, any barbs that are generally triangular in shape may be generally right-triangle-shaped, obtuse-triangle-shaped or acute-triangle-shaped.

Other exemplary embodiments of the disemboweling tool 100 omit the fins 130, with the barbs 132, 134 and/or the like extending directly from the shank 120. In such exemplary embodiments, the barbs 132, 134 and/or the like can be arranged in two or more columns extending along the length of the shank 120 (similar to the fins 120), can be arranged to simulate one or more spiraling fins 130, can be distributed about the length and circumference of the shank 120 in a pattern that repeats either around the circumference and/or along the length of the shank 120, and/or can be distributed randomly about the length and circumference of the shank 120.

For example, in various exemplary embodiments, a plurality of the barbs 132, 134 and/or the like can extend from the shank 120, with the plurality of the barbs 132, 134 and/or the like distributed around the shank 120 such that there are two or more distinct belts, rings or bands of barbs extending around the circumference of the shank 120 at two or more points along the length of the shank 120, whether or not in distinct columns or the like. Similarly, in various exemplary embodiments, a plurality of the barbs 132, 134 and/or the like can extend from the shank 120, with the plurality of the barbs 132, 134 and/or the like distributed along the length of the shank 120 such that there are two or more distinct strings, courses or series of barbs extending along the length of the shank 120 at two or more points or regions around the circumference of the shank 120, whether or not in distinct bands or the like. Of course, in various exemplary embodiments, the plurality of the barbs 132, 134 and/or the like can be distributed around the shank 120 using both of these protocols.

In general, the tool 100, or at least a portion of the tool 100 (e.g., the at least one fin 130 and/or the multiple barbs 132 and 134) is designed to easily enter a gastrointestinal tract of an animal carcass, such as, for example, to easily enter or pass through the cloaca of a bird. Likewise, in general, the tool 100, or at least a portion of the tool 100, is designed to engage (e.g., grab) the gastrointestinal tract and/or other internal organs of the animal carcass such that, when the tool 100 is removed from the animal carcass, a portion of the gastrointestinal tract and/or other internal organs is removed with the tool 100.

As such, in various exemplary embodiments, the fins 130 are generally tapered or conically shaped to improve the ability of the tool 100 to enter the gastrointestinal tract of the animal. That is, in various exemplary embodiments, the large barbs 132 and small barbs 134 on one end of each fin 130 (e.g., adjacent to the handle 110) extend further from the shaft 120 than do the corresponding large barbs 132 and small barbs 134 on an opposing end of the fin 130 (e.g., adjacent to the point 122). Likewise, in various exemplary embodiments, the shape of the point 122 is substantially conical, which tends to make it easier to insert the point 122 of the shank 120 into the gastrointestinal tract of the animal. Further, the shank 120, the fins 130 and/or the barbs 132 and/or 134, may include other structures and/or surfaces (e.g., textured surfaces or hooks) that improve the ability of the tool 100 to engage the gastrointestinal tract and/or other internal organs of the animal carcass being field dressed before the tool 100 is removed from the animal carcass.

It should be appreciated that the fins 130 may extend from the point 122 to the handle 110. In various exemplary embodiments, the fins 120 start at a first distance from the point 122 toward the handle 110. In various exemplary embodiments, the fins 120 end at a second distance from the point 122 toward the handle 110. It should also be appreciated that, in general, the shaft 120 and the handle 110 of the tool 100 are desirably long enough that a user's hand is comfortably removed from the animal carcass when the tool 100 is held by the user and is sufficiently inserted into the animal's gastrointestinal tract. It should also be appreciated that the handle 110, the shank 120, the fins 130 and/or the barbs 132 and 134 may be hollow or solid, depending on the material used and a desired weight for the tool 110.

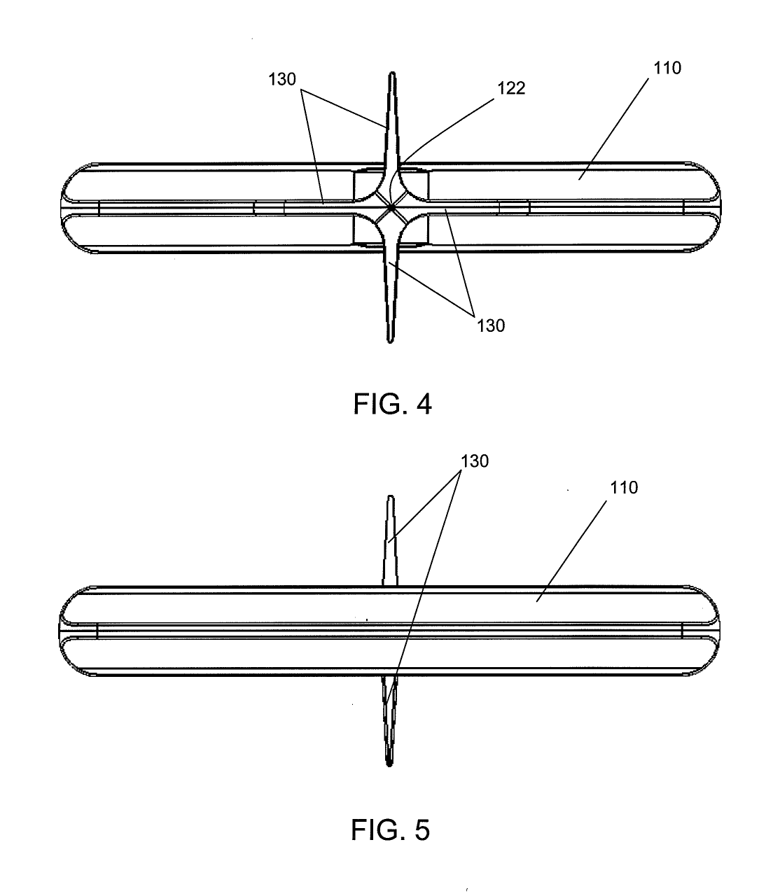

It should be appreciated that, while the handle 110 is shown in FIGS. 1-5 as a generally rod-like member extending perpendicularly to the shank 120, the handle 110 may take other suitable forms. For example, in various other exemplary embodiments, the handle 110 is a linear extension of the shank 120 (e.g., the handle 110 and the shank 120 are substantially coaxial). Likewise, in still other exemplary embodiments, the handle 110 is a loop or aperture formed in the shank 120 that is also usable to grip or carry the tool 100. Additionally, in various exemplary embodiments, the handle 110 has and/or includes structures or surfaces that improve a grip or comfort level of the handle 110 (e.g., textured or padded surfaces and/or projections and/or indentation that align with a typical user's closed hand).

It should also be appreciated that the handle 110 may have any desired cross-section. For example, the handle 110 may have a circular cross-section, a square, rectangular or other polygonal cross-section, an elliptical cross-section or any other desired cross-section. Additionally, the handle 110 may be bent, curved or otherwise straight or linear.

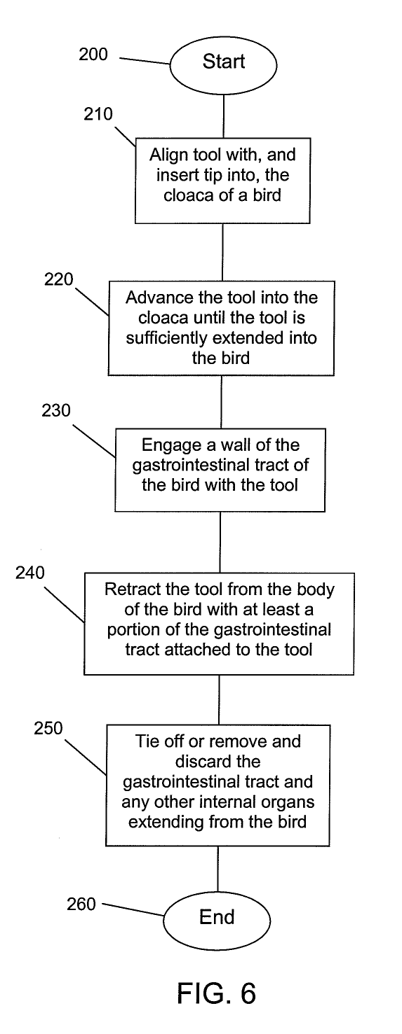

FIG. 6 is a flowchart that outlines an exemplary embodiment of a method for using a tool (e.g., the exemplary tool 100 shown in FIGS. 1-5) to disembowel an animal carcass, such as a bird. As shown in FIG. 6, beginning in step 200, operation of the method continues to step 210, where the tip of the tool is aligned with, and inserted into, the cloaca of the bird. Then, in step 220, the tool is further advanced (e.g., inserted) through the cloaca and into the bird's carcass (e.g., into a body cavity of the animal carcass). The tool is advanced a desired distance, which is typically at least until the tool is sufficiently extended into the animal. For example, in an exemplary embodiment using the exemplary tool 100 shown in FIGS. 1-5, the tool 100 is advanced until the point 122 and a sufficient portion of the at least one fin 130 (e.g., a sufficient number of the barbs 132 and 134 of the at least one fin 130) are positioned within the gastrointestinal tract to ensure a substantially clean disembowelment of the bird.

It should be appreciated that, in general, when the tool is inserted into the animal, the gastrointestinal tract may stretch radially to accommodate the tool and may at least partially engage at least some of the barbs of the tool. It should also be appreciated that, in general, the gastrointestinal tract will not tear, rip or rupture when the tool is inserted through the cloaca. In various exemplary embodiments, the conical shape of the tip, fins, barbs and/or tool in general may help avoid tearing, ripping or rupturing the gastrointestinal tract as the tool is inserted through the cloaca.

Next, in step 230, the tool engages a wall of the gastrointestinal tract. In various exemplary embodiments, the user manipulates the tool (e.g., rotates the tool, partially withdraws the tool, etc) to engage the wall of the gastrointestinal tract. Operation then continues to step 240.

For example, the user rotates the tool either clockwise or counterclockwise, about an axis of the shank so that the barbs engage, or further engage, the gastrointestinal tract. Furthermore, as outlined above, in various exemplary embodiments, at least some of the barbs of at least one fin may be formed along a series of planes that do not pass through the rotational axis of the shank and/or are askew to a plane of that fin. In such exemplary embodiments, the tool may be rotated in a specific direction to cause the barbs to more securely engage the gastrointestinal tract (e.g., by hooking into or grasping at least a portion of the gastrointestinal tract). In various other exemplary embodiments, the tool may be manipulated in other ways. For example, the tool may be rotated about the tip of the shank (e.g., perpendicular to the axis of the shank) or partially retracted in a sharp motion. In general, manipulating the tool helps the barbs engage the gastrointestinal tract, by, for example, digging into and grasping at least a portion of the gastrointestinal tract. It should be appreciated that, in various exemplary embodiments, the tool may at least partially engage the gastrointestinal tract without needing to be manipulated.

In step 240, the tool is retracted (e.g., withdrawn) from the bird carcass, drawing the gastrointestinal tract, either partially or fully, through the cloaca and outside of the bird carcass. If partially extracted, the section of the gastrointestinal tract outside of the bird may then be clamped, tied off with cord or rubber band, or tied into a knot. This helps prevent solid waste from escaping from the gastrointestinal tract during the rest of the process of eviscerating the slain bird. Twisting the gastrointestinal tract outside the body cavity of the bird carcass prior to clamping may further prevent waste leakage.

Next, in step 250, any portions of the gastrointestinal tract and/or any portions of other internal organs that now extend out of the bird may be removed and discarded. Operation then continues to step 260, where the methods ends. It should be appreciated that in various exemplary embodiments, the bird carcass is further dressed, eviscerated, or otherwise processed with the withdrawn portion of the gastrointestinal tract, removed, tied and/or clamped to prevent waste leakage. For example, the extended portion of the gastrointestinal tract may be further pulled through the cloaca with remaining interior portions of the gastrointestinal tract after the lower abdominal skin has been opened. The rest of the internal organs may then be removed through the abdominal opening.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A tool usable to disembowel an animal, comprising:
a handle;
a shank extending from the handle and having a tip;
at least one fin extending from the shank; and
a plurality of barbs provided in or on each of the at least one fin.

2. The tool of claim 1, wherein the shank extends generally perpendicularly from the handle.

3. The tool of claim 2, wherein the shank extends from an approximate center of the handle.

4. The tool of claim 1, wherein the handle and the shank are generally coaxial.

5. The tool of claim 1, wherein the handle has a graspable aperture.

6. The tool of claim 1, wherein at least one fin extends along the shank from adjacent the tip of the shank toward the handle.

7. The tool of claim 1, wherein at least one fin is generally planar.

8. The tool of claim 1, wherein the at least one fin comprises a plurality of fins.

9. The tool of claim 8, wherein the plurality of fins are approximately equally distributed about an axis of the shank.

10. The tool of claim 9, wherein the plurality of fins comprises an even number of fins.

11. The tool of claim 10, wherein opposing ones of the fins are generally symmetrically designed.

12. The tool of claim 1, wherein at least one of the barbs of at least one fin is provided askew to a plane of that fin.

13. The tool of claim 1, wherein at least some of the plurality of barbs are generally triangular shaped with one edge connected to the shank.

14. The tool of claim 1, wherein the plurality of barbs comprises at least one barb having a first design and at least one barb having a second design.

15. The tool of claim 14, wherein:
the tool includes a plurality of fins, and
at least some barbs of the first design are located on at least one of the plurality of fins at approximately the same distance down the shank from the tip as corresponding barbs of the second design on an adjacent fin.

16. A method for disemboweling an animal carcass using a tool, the tool comprising a handle, a shank extending from the handle and having a tip, at least one fin extending from the shank and a plurality of barbs provided in or on each of the at least one fin, the method comprising:
inserting at least two of the plurality of barbs in or on each of the at least one fin of the tool into the animal carcass;
engaging a portion of a gastrointestinal tract of the animal carcass with at least some of the at least two of the plurality of barbs in or on each of the at least one fin of the tool;
extracting the tool from the animal carcass such that at least a portion of a gastrointestinal tract is withdrawn from the animal carcass with the tool.

17. The method of claim 16, wherein inserting at least two of the plurality of barbs in or on each of the at least one fin of the tool into the animal carcass comprises inserting at least two of the plurality of barbs in or on each of the at least one fin of the tool into a cloaca of a bird carcass.

18. The method of claim 16, wherein engaging a portion of a gastrointestinal tract of the animal carcass with at least two of the plurality of barbs in or on each of the at least one fin of the tool comprises rotating the tool about an axis of the shank while at least some of the at least two of the plurality of barbs in or on each of the at least one fin of the tool are inserted into the portion of a gastrointestinal tract.

19. The method of claim 16, wherein engaging a portion of a gastrointestinal tract of the animal carcass with at least some of the at least two of the plurality of barbs in or on each of the at least one fin of the tool comprises partially extracting at least some of the at least two of the plurality of barbs in or on each of the at least one fin of the tool from the animal in a single sharp motion.

20. The method of claim 16, wherein extracting the tool comprises extracting the tool such that at least a portion of one other internal organ is also removed from the animal carcass.

21. A tool usable to disembowel an animal, comprising:
a handle;
a shank extending from the handle and having a tip; and
a plurality of barbs extending from the shank, wherein the plurality of barbs are distributed on the shank such that there are at least two distinct bands of barbs extending around a circumference of the shank, each band including a plurality of barbs.
